(19) United States
(12) Patent Application Publication
(10) Pub. No.: US 2014/0131979 A1
(43) Pub. Date: May 15, 2014

(54) Self Actuated Trailer Ball Hitch

(71) Applicant: TIE DOWN, INC., Atlanta, GA (US)

(72) Inventors: Charles J. MacKarvich, Atlanta, GA (US); Timothy Joseph Prelac, Kennesaw, GA (US)

(73) Assignee: TIE DOWN, INC., Atlanta, GA (US)

(21) Appl. No.: 13/675,486

(22) Filed: Nov. 13, 2012

(51) Int. Cl. B60D 1/06

(52) U.S. Cl. CPC B60D 1/065
USPC 280/511

(57) ABSTRACT

A ball clamp 30 has a semi-spherical surface that is urged by coil compression spring 34 into engagement with the spherical surface of a hitch ball. An L-shaped flange 73 on the rear of the ball clamp guides the groove 75 along the length of the sloped guide tongue 69 of the ball clamp support 65, assuring that the ball clamp 30 is properly supported and accurately positioned during its movements toward and away from the ball hitch 12.

### CROSS REFERENCE

This is a continuation-in-part of U.S. patent application Ser. No. 13/172,014 filed in the U.S. Patent & Trademark Office on Jun. 29, 2011.

### FIELD OF THE INVENTION

This invention generally comprises a trailer hitch that is used to connect a towed trailer to the hitch ball of a towing vehicle. More particularly, the invention concerns a trailer hitch that automatically locks itself to the hitch ball of the towing vehicle.

### BACKGROUND OF THE INVENTION

Trailer hitches for small vehicles usually include a socket that connects to a hitch ball mounted on the rear end of a towing vehicle. The trailer usually includes a forwardly extending trailer draft tongue that includes a coupler having the downwardly facing ball socket that is to be placed over and pivotally connects to the upwardly extending hitch ball.

When the towing vehicle is to be connected to the trailer, the operator typically elevates the trailer tongue so that the socket of the coupler is at a slightly higher level than the level of the hitch ball that is carried by the towing vehicle. The operator backs the towing vehicle toward the anticipated position of the socket of the coupler until the operator estimates that the hitch ball is aligned below the socket of the coupler. The operator then stops the vehicle, exits the vehicle and lowers the trailer tongue until the socket of the hitch registers with the hitch ball and the trailer is mounted to the hitch ball.

It is important that the ball socket of the coupler is properly mounted on and is locked to the hitch ball, and most trailer hitches include a lever actuated clamp that is movable to extend a locking element from the trailer hitch to a position toward the neck of the hitch ball, below the larger lateral breadth of the hitch ball, for locking the trailer hitch to the hitch ball of the towing vehicle. Without this type of lock, there is a hazard that the trailer hitch will tend to bounce off the hitch ball upon the vehicle and/or the trailer passing over bumps in the road, or upon braking or accelerating, or upon side forces received from winds, or turns of the towing vehicle, etc., or upon the trailer being out of balance. Accordingly, the driver of a towing vehicle, when in the driver's position within the vehicle, is not likely to remain in the vehicle and to allow someone else to lock the trailer hitch to the hitch ball of the towing vehicle. This means that the driver is likely to apply the emergency brakes to the towing vehicle, exit the truck, and then make sure that the lock is secure between the trailer and the towing vehicle. While this operation is likely to increase the safety of the connection between the towing vehicle and the trailer, it leaves the towing vehicle and the trailer unattended for accidental movement during the locking procedure. Also, it is possible that the conventional clamp device used to connect the trailer top to the ball hitch might be inadvertently left open or could be accidently engaged by another obstacle that causes the clamp to open.

It is to the above described problem that the following disclosure is directed.

### SUMMARY OF THE DISCLOSURE

Briefly described, the present disclosure concerns a trailer hitch for mounting the draw bar of a trailer to a conventional hitch ball of a towing vehicle. The hitch ball typically includes a dome shaped upper portion and a lower portion that converges beneath the larger lateral breadth of the dome shaped upper portion to a stem of a smaller breadth. The trailer hitch may include a socket housing that includes a downwardly facing ball socket for mounting on the upwardly facing hitch ball. The ball socket may define a downwardly facing semi-spherical upper interior surface that corresponds in size and shape to the semi-spherical hitch ball.

A ball clamp may be supported by the socket housing for engaging the hitch ball at the stem of the hitch ball below the larger intermediate lateral breadth of the hitch ball for locking the trailer hitch to the hitch ball of the towing vehicle.

The trailer hitch herein disclosed may include a ball clamp with a concave surface that is substantially coextensive with the semi-spherical interior surface of the ball socket when engaging the hitch ball at the stem of the hitch ball below the larger lateral breadth of the hitch ball.

The concave surface of the ball clamp may include an arcuate surface, and a biasing means may be supported by the socket housing for urging the ball clamp toward the hitch ball at the stem of the hitch ball for locking the ball clamp to the hitch ball.

The biasing means may include a coil compression spring that engages the ball clamp, and a clamp pin may be connected to the ball clamp with a coil compression spring surrounding the clamp pin for urging the ball clamp toward its locked position.

The trailer hitch may include a ball clamp movably supported by a ball socket assembly, a ball clamp support mounted to the ball socket assembly configured to guide the ball clamp toward and away from its locking position and for supporting the ball clamp when the ball socket is mounted on the hitch ball with the ball clamp in its locking position.

The ball clamp and the ball clamp support may include a tongue and groove connection that guides the ball clamp along the clamp support. In one embodiment a sloped guide tongue extends parallel to the path of movement of the ball clamp, and the ball clamp includes an L-shaped flange that forms a tongue groove that is sized and shaped to receive the sloped guide tongue and guide the ball clamp along the sloped guide tongue toward and away from its locking position.

A lever is mounted on the ball socket assembly that includes an intermediate portion connected to the clamp pin, a handle extending from the intermediate portion over the ball socket, and a fulcrum extending from the clamp pin opposite to the handle. The handle may include a protrusion that nests with a recess formed in the ball socket, for stabilizing the handle when not in use.

The ball socket may define a lock pin opening that is directed through the path of movement of the ball clamp, and a lock pin sized and shaped to extend through the lock pin opening for locking the ball clamp in position below the larger lateral breadth of the hitch ball. The ball socket assembly may include a shield mounted to the ball socket beneath the ball clamp and shaped to cover the bottom surface of the ball clamp and define a circular recess for admitting a hitch ball to move into engagement with said ball clamp.

The above described features of this disclosure, as well as the others hereinafter described, provide a trailer hitch that, when applied to the hitch ball, is self-locking. The trailer hitch has a clamp that is urged out of the way when the hitch socket is lowered onto the hitch ball to allow the socket to become properly placed on the hitch ball, and once properly positioned on the hitch ball, the clamp is biased into locking engagement with the hitch ball.

This provides the vehicle operator with the knowledge that once the trailer hitch is mounted to the hitch ball, it is locked in place and does not require his personal attention to properly secure the trailer hitch to the hitch ball. This reduces the hazard of improper locking of the trailer hitch to a hitch ball.

### BRIEF DESCRIPTION OF THE DRAWINGS

FIG. 1 is a top view of a trailer hitch assembly.

FIG. 2 is a side cross sectional view of the trailer hitch of FIG. 1.

FIG. 3 is a perspective phantom view of the trailer hitch of FIGS. 1 and 2, with the lever in its locked position.

FIG. 4 is a perspective phantom view of the trailer hitch of FIG. 3, but showing the lever in its open position

FIG. 5 is a side view of the ball clamp, lever, coil spring and the shape of a portion of the ball socket, with the ball clamp and top wall of the ball socket shown in cross section.

FIG. 6 is a top view of the ball clamp.

FIG. 7 is back view of the ball clamp, clamp pin, spring and lever, taken along lines 7-7 of FIG. 5.

FIG. 8 is a front view of the ball clamp, clamp pin, spring and lever, taken along lines 8-8 of FIG. 5.

FIG. 9 is a cross sectional view of the ball hitch, showing the movement of the ball clamp as the ball hitch is moved down onto a hitch ball.

FIG. 10 is a cross sectional view of the ball hitch, showing how the ball clamp is moved upwardly in response to opening the lever.

FIG. 11 is a perspective view of the ball clamp and the ball clamp support in an expanded relationship, showing the movement of the ball clamp along the tongue of the ball clamp support.

### DETAILED DESCRIPTION

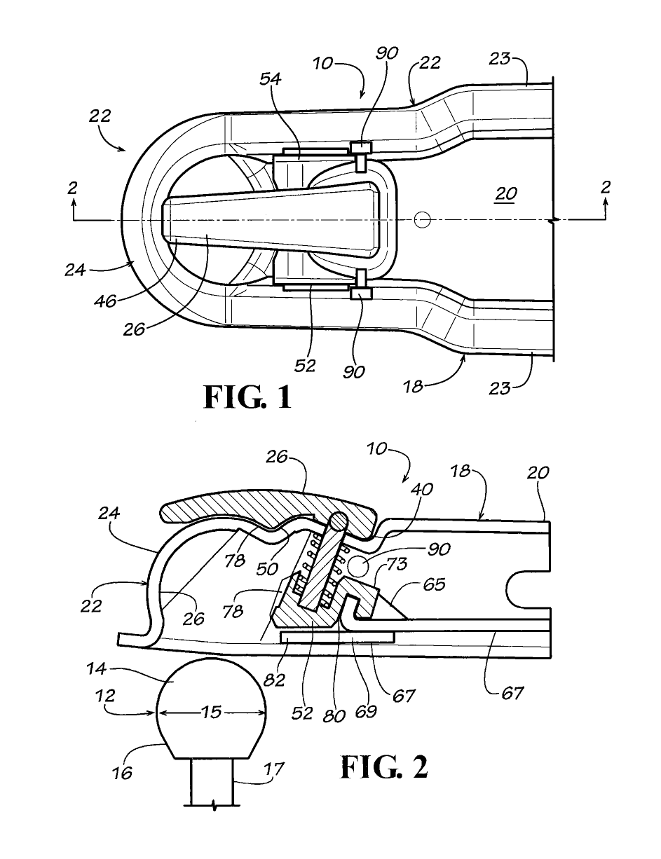

Referring now in more detail to the drawings, in which like numerals indicate like parts throughout the several views, FIGS. 1 and 2 illustrate a trailer hitch 10 that is to be mounted to a hitch ball 12 that is projected from the rear of a towing vehicle (not shown) in a conventional manner. The hitch ball 12 is semi-spherical, including a semi-spherical upper portion 14 having a lateral breadth 15, and a converging lower portion 16, with a support stem 17 that extends downwardly to the device that connects the hitch ball to the towing vehicle (not shown). This is conventional.

Trailer hitch 10 includes a mounting sleeve 18 that is mounted to the forward end of a draw bar (not shown) that extends back to the trailer that is to be towed. The mounting sleeve 18 typically will be formed in an inverted U-shape, with a horizontal top wall 20 and opposed vertically oriented side walls 23. Mounting sleeve 18 supports at its forward end the trailer hitch 10, and may also support the brake cylinders, electrical wiring and other components not further described herein.

As shown in FIG. 2, the trailer hitch 10 is to be mounted on the conventional hitch ball 12, by resting on the semi-spherical shape that includes the dome-shaped upper portion 14 that expands downwardly to the large lateral intermediate breadth 15, then converges to the lower portion.

The trailer hitch 10 includes a ball socket assembly 22 for mounting on the hitch ball, with the ball socket assembly including a ball socket 24 that is to be mounted to the hitch ball.

The ball socket includes a concave interior upper surface 26 that corresponds in size and shape to the semi-spherical upper portion 14 of the hitch ball 12 for mounting about the semi-spherical upper portion of the hitch ball.

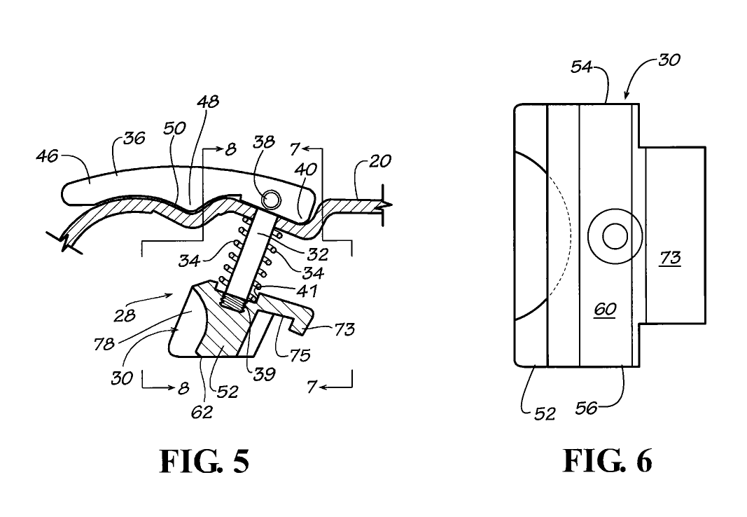

As shown in FIG. 5, a ball clamp assembly 28 includes a ball clamp 30, a clamp pin 32, a coil compression spring 34, a lock lever 36, and a connector pin 38. The ball clamp 30 includes an internally threaded bore 39 and a counter bore 41 that extend downwardly through its upper surface. Clamp pin 32 is threaded at its lower end into the threaded bore so as to be threadedly connected in the threads of the ball clamp 30.

Coil compression spring 34 surrounds the clamp pin and its lower end fits into the counter bore 41. The clamp pin 32 extends up through horizontal top wall 20, and the lock lever 36 is positioned on the top wall 20 of the ball socket and is connected intermediate its ends by means of the connector pin 38 to the upper end of the clamp pin so that it pivots about the connector pin at the top of the clamp pin 32.

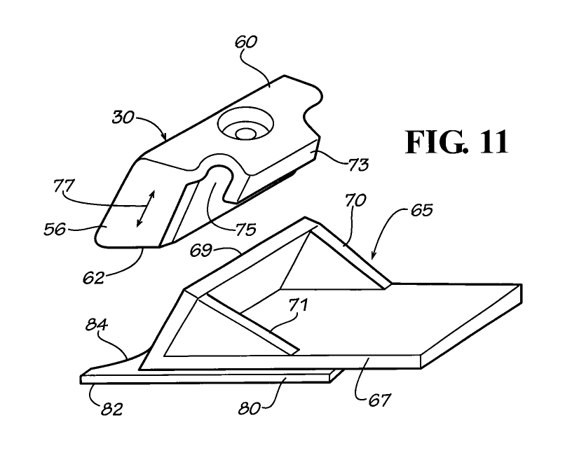

The connector pin 38 and the upper end of the clamp pin 32 are displaced laterally from the rear end of the lock lever 36 so that the rear end of the lock lever includes a bearing point 40 that functions as a moving fulcrum when the lock lever 36 is raised, as shown in FIG. 10. The bearing point 40 is tilted downwardly from the connector pin, from the position shown in FIG. 5 to the position shown in FIG. 10, by lifting the lock lever 36 in the direction as indicated by arrow 42 of FIG. 10, causing the clamp pin 32 to withdraw upwardly through the horizontal top wall 20 of the mounting sleeve 18. By lifting the lock lever 36 as shown in FIG. 10, the connector pin 38 pulls the ball clamp 30 upwardly as shown by arrow 77 of FIG. 10, causing the coil compression spring 34 to be compressed between the facing surfaces.

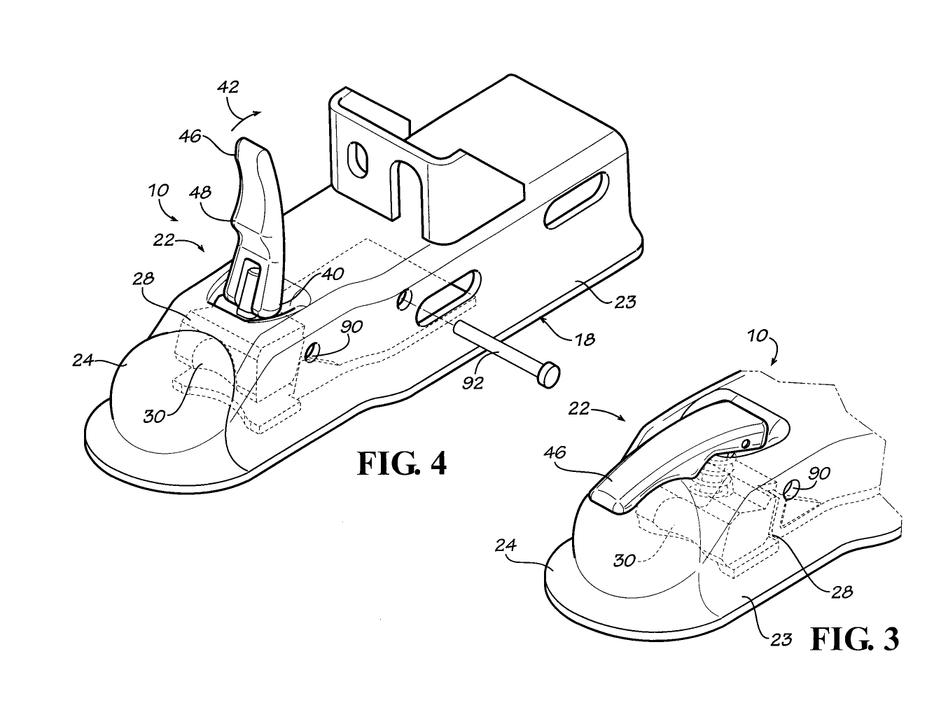

The lifting end 46 of the lock lever 36 is directed forwardly of the mounting sleeve 18, and the lower surface of the lock lever has a downwardly facing protrusion 48. A recess 50 is formed in the horizontal top wall 20 of the mounting sleeve 18 that receives and nests with the protrusion 48 of the lock lever. The nesting between the protrusion 48 and recess 50 tends to provide stability to the lock lever 36 so that the lock lever tends to remain in its nested configuration when the lock lever is lowered back to its locked position shown in FIGS. 1, 2, 3, 5, and 9.

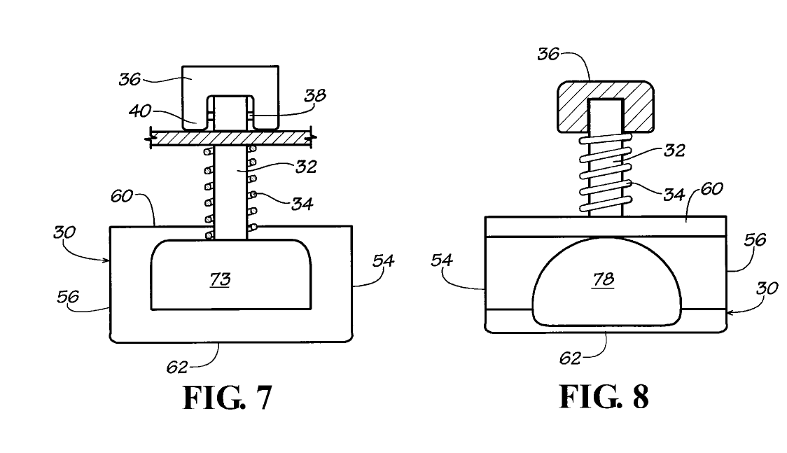

As shown in FIGS. 5-8, ball clamp 30 includes a top wall 60, end walls 54 and 56, and bottom wall 62.

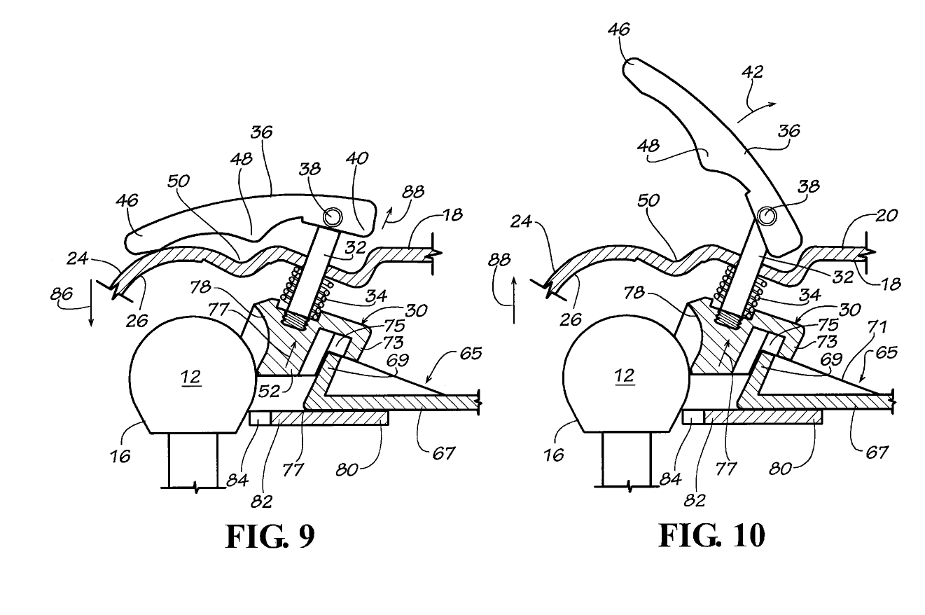

As shown in FIGS. 9, 10 and 11, a ball clamp support 65 is positioned adjacent the ball clamp 30 and is supported by and suspended between the opposed side walls 23 of the mounting sleeve 18 of the trailer hitch 10. The ball clamp support 65 includes a horizontal platform 67 and upturned, sloped tongue 69, and opposed side wings 70 and 71 that extend between the edge of the horizontal platform 67 and the edges of the sloped tongue 69.

Ball clamp 30 includes a laterally extending L-shaped flange 73 that forms a groove 75 that is sized and shaped to receive the sloped guide tongue 69 of the ball clamp support 65. This forms a tongue and groove relationship between the ball clamp support 65 and the ball clamp 30 so that the L-shaped flange 73 requires the ball clamp 30 to move in an upwardly sloped direction as indicated by arrow 77 when the trailer hitch 10 is to be withdrawn from or mounted onto the hitch ball 12, as indicated in FIGS. 9 and 10.

The main body portion 52 of the ball clamp 30 further includes a semi-spherical bearing surface 78 that corresponds in size and shape to the adjacent surface of the hitch ball 12 so that when the ball clamp 30 is moved by its coil compression spring 34 downwardly against the direction of arrow 77 in FIGS. 9 and 10, the semi-spherical bearing surface 78 forms an extension of the inner surface of the ball socket and engages the hitch ball 12 at a position adjacent the converging lower portion 16 of the hitch ball, thereby locking the trailer hitch 10 to the hitch ball 12.

The tongue and groove relationship established between the ball clamp support 65 and the ball clamp 30 assures that the movement of the ball clamp 30 is always sloped toward or away from its locking position with respect to the hitch ball 12. Further, the L-shaped flange 73 limits the downward movement of the ball clamp 30, assuring that the ball clamp will be moveable between the desired up and down positions within the trailer hitch 10.

As shown in FIGS. 2, 9, 10 and 11, a shield plate 80 is supported at its side edges to the opposed side walls 23 of the mounting sleeve 18 and extends horizontally beneath the ball clamp 30 of the trailer hitch and projects out from beneath the horizontal platform 67 of the ball clamp support 65, with the projection 82 defining an arcuate edge 84 formed so as to be compatible with the curvature of the hitch ball 12. The shield plate 80 tends to guide the downwardly facing opening formed by the ball socket 24 to accurately receive the hitch ball, without likelihood that the hitch ball will engage the bottom surface of the ball clamp 30, thereby protecting against aggressive forces being applied to the ball clamp 30. The L-shaped flange 73 and its groove 75 are dimensioned so that a smooth sliding relationship is formed between the ball clamp 30 and the ball clamp support 65, and so that the ball clamp 30 moves downwardly adjacent to, but preferably not in contact with, the shield plate 80, as shown by the dash lines in FIG. 10. This avoids the ball clamp from applying a downward force on the shield plate 80.

As shown in FIG. 9, when the trailer hitch 10 is to be mounted on the hitch ball 12, the trailer hitch is moved downwardly as indicated by arrow 86, so that the ball clamp 30 is engaged against the hitch ball 12, causing the ball clamp to be lifted as indicated by arrow 77. It will be noted that the sloped direction of upward movement of the ball clamp tends to move the ball clamp out of the way of the oncoming hitch ball 12 until the hitch ball has fully entered the ball socket 24, whereupon the coil compression spring urges the ball clamp 30 downwardly to its locked position as shown in FIG. 2. In the meantime, as the ball clamp moves upwardly within the ball socket 24, and the upward movement of the ball clamp tends to lift the lock lever 36 as shown by arrow 88 of FIG. 9. Once the ball socket 24 has been fully mounted to the hitch ball 12, the coil compression spring 34 moves the ball clamp downwardly in the direction opposite to arrow 77 until the L-shaped flange 73 rests upon the sloped guide tongue 69, as previously described.

When it is desired to remove the ball socket assembly 22 from its mounting position on the ball hitch 12, the lock lever 35 is lifted so that it moves in the direction indicated by arrow 77 which, in turn, lifts the ball clamp against the bias of its coil compression spring 34 as shown in FIG. 10, thereby opening the ball socket 24 so that the trailer hitch 10 can be lifted off the hitch ball 12.

The sloped guide tongue 69 tends to stabilize the ball clamp 30 during its up and down movements, and also when the trailer tends to over-run the hitch ball resulting from the braking force applied by the towing vehicle to the trailer.

Although preferred embodiments of the invention have been disclosed in detail herein, it will be obvious to those skilled in the art that variations and modifications of the disclosed embodiments can be made without departing from the spirit and scope of the invention as set forth in the following claims.

1. A trailer hitch for mounting the draw bar of a trailer to a hitch ball of a towing vehicle, the hitch ball of the towing vehicle including a semi-spherical upper portion and a lower portion that converges beneath the larger lateral breadth of the semi-spherical upper portion to a stem of smaller breadth,
said trailer hitch comprising:
a ball socket assembly for mounting on the hitch ball, said ball socket assembly defining a ball socket including a concave interior upper surface that corresponds in size and shape to the semi-spherical upper portion of the hitch ball for mounting about the semi-spherical upper portion of said hitch ball, and
a ball clamp movably supported by said ball socket assembly, said ball clamp including a concave ball engaging surface that corresponds in size to the lower portion of the hitch ball for engaging the hitch ball of the towing vehicle at the stem of the hitch ball below the larger lateral breadth of the hitch ball for locking the trailer hitch to the hitch ball of the towing vehicle, and
a ball clamp support mounted to said ball socket assembly configured to guide the ball clamp toward and away from its locking position and for supporting said ball clamp when said ball socket is mounted on the hitch ball with the ball clamp in its locking position.

2. The trailer hitch of claim 1, wherein said ball clamp and said ball clamp support include a tongue and groove connection that guides the ball clamp along said clamp support.

3. The trailer hitch of claim 2, wherein said ball clamp support includes a clamp tongue that extends parallel to the path of movement of said ball clamp and said ball clamp includes a tongue groove that is sized and shaped to receive said clamp tongue and guide said ball clamp toward and away from its locking position

4. The trailer hitch of claim 3, and further including a biasing means supported by said ball socket assembly for urging said ball clamp along said clamp tongue toward the hitch ball at the stem of the hitch ball.

5. The trailer hitch of claim 4, wherein said biasing means comprises a coil compression spring engaging said ball clamp.

6. The trailer hitch of claim 1, and further including a clamp pin connected to said ball clamp, a coil compression spring surrounding said clamp pin, a lever connected to said clamp pin for moving said ball clamp along said clamp tongue from below the hitch ball.

7. The trailer hitch of claim 6, and further including
a lever mounted on said ball socket and including an intermediate portion connected to said clamp pin, and a handle extending from said intermediate portion over said ball socket, and a fulcrum extending from said clamp pin opposite to said handle,
said handle including a protrusion extending from toward said ball socket, and
said ball socket including a recess for receiving said handle protrusion.

8. The trailer hitch of claim 1, wherein said ball socket defines a lock pin opening that is directed through the path of movement of said ball clamp, and a lock pin sized and shaped to extend through said lock pin opening for locking said ball clamp in position below the larger lateral breadth of the hitch ball.

9. The trailer hitch of claim 1 and wherein said ball socket assembly includes a shield mounted to said ball socket beneath said ball clamp and shaped to cover the bottom surface of said ball clamp and defining a circular recess for admitting a hitch ball to move into engagement with said ball clamp.

10. The trailer hitch of claim 1, and further including
a lock pin opening defined by said ball socket positioned over said ball clamp when said ball clamp extends into engagement with said hitch ball, and
a lock pin sized and shaped to extend through said lock pin opening over said ball clamp for locking said ball clamp in engagement with the hitch ball.

11. A ball clamp for mounting in a ball socket of a trailer hitch comprising:
a concave recess on one side of said ball clamp for engaging a hitch ball,
a groove on the other side of said ball clamp for receiving a guide tongue.

12. The ball clamp of claim 11, and further including
a ball clamp support that includes a guide tongue sized and shaped to slidably receive said groove of said ball clamp and to guide said ball clamp toward and away from clamping relationship with respect to the hitch ball.

13. A trailer hitch for mounting the draw bar of a trailer to a semi-spherical hitch ball of a towing vehicle, the hitch ball of the towing vehicle including a dome-shaped upper portion that diverges downwardly to a larger breadth intermediate portion and converges in its lower portion from the large breadth intermediate portion toward a stem of smaller breadth,
said trailer hitch comprising a socket housing defining a ball socket for mounting on the hitch ball, said ball socket defining an interior upper surface that corresponds in size and shape to the dome shaped upper portion of the hitch ball for surrounding and resting on the dome shaped upper portion of said hitch ball, and a lower portion that is shaped to converge beneath the dome shaped upper portion of the hitch ball for retaining the ball socket on said hitch ball, and
said lower portion of said ball socket including a ball clamp for extending toward the lower portion of said hitch ball and is movable away from said hitch ball for forming an opening in said ball socket large enough for the passage of said hitch ball into said ball socket,
a ball clamp support including a guide tongue,
said ball clamp including a groove aligned with said guide tongue for slidably engaging said guide tongue for guiding said ball clamp toward and away from engagement with the hitch ball,
biasing means carried by said socket housing for urging said clamp toward said lower portion of said ball socket.

14. The trailer hitch of claim 13, wherein said clamp extends about the lower portion of the hitch ball and forms a portion of said ball socket.

15. The trailer hitch of claim 13, wherein said biasing means comprises a coil spring, and a lever is pivotally mounted to said socket housing and is connected to said clamp and moves said clamp against the bias of said spring for withdrawing the clamp from said ball socket.

16. In a trailer hitch for connection to a hitch ball,
a ball clamp including a concave surface on one side of said ball clamp movable with said ball clamp toward and away from the hitch ball,
a spring biased against said ball clamp positioned to urge said concave surface of said ball clamp toward engagement with the hitch ball,
a ball clamp support positioned adjacent said ball clamp, and
said ball clamp and said ball clamp support together defining a tongue and groove slidable connection for guiding said concave surface of said ball clamp toward and away from engagement with the ball hitch.

17. The invention of claim 16, wherein said tongue and groove slidable connection comprises a tongue extending from said ball clamp support and a groove formed by said ball clamp that receives said tongue.
